(19) United States
(12) Patent Application Publication
(10) Pub. No.: US 2002/0180820 A1
(43) Pub. Date: Dec. 5, 2002

(54) PRINTING APPARATUS AND PRINTING METHOD

(76) Inventor: YUJI TSURUOKA, KAWASAKI-SHI (JP)

Correspondence Address: FITZPATRICK CELLA HARPER & SCINTO, 30 ROCKEFELLER PLAZA, NEW YORK, NY, 10112, US

(21) Appl. No.: 09/219,897

(22) Filed: Dec. 24, 1998

(30) Foreign Application Priority Data
Dec. 29, 1997 (JP) 369,108/1997

(51) Int. Cl. B41J 2/195

(52) U.S. Cl. 347/19; 347/7

(57) ABSTRACT

When the exchanged ink tank is considered as “brandnew” by the information writing circuit 35, the first fuse is blown. The third fuse to the fifth fuse are blown according to individual discrimination number next to the used individual discrimination number stored in the RAM 32. Then, the integrating counter according to individual discrimination number is selected and this selected counter value is reset. On the other hand, when the exchanged ink tank is considered as “used”, individual discrimination number written by the third fuse to the fifth fuse is read out, and the integrating counter according to individual discrimination number is selected. The number of printing dots per line is counted and integrating value is compared to the predetermined waste count number of ink per line. When integrating value is over the waste count number, an empty message is shown on the display portion 36.

This application is based on Patent Application No. 369,108/1997 filed on Dec. 29, 1997 in Japan, the content of which is incorporated hereinto by reference.

### BACKGROUND OF THE INVENTION

1. Field of the Invention

The present invention relates to a printing apparatus having a mounting portion for an exchangeable ink tank.

2. Description of the Related Art

Whether ink remains in the ink tank of the ink-jet printing apparatus or not can confirm by looking ink in the transparent ink tank. But, it is difficult for a user to check ink remain in a type of ink tank storing the ink permeated into the sponge or the porous member.

To detect ink remain in this type of ink tank, for example, there is a method which integrates the number of printing dots and calculates ink consumption from the integrated value to detect ink remain. However, in the case of using a plurality of the exchangeable ink tanks, ink remain detected by the above integrating method does not correspond to ink remain stored in each ink tank.

When the printing apparatus is used by exchanging a plurality of the ink tanks, it is considered that the ink cartridge with the predetermined barcode is utilized and a plurality of the ink tanks are distinguished. However, since some of the ink tanks seem to be the ink cartridges with the same barcode, it may be distinguished by mistake and it is difficult to discriminate the ink tanks with the barcode individually. In the above construction, since it is difficult to distinguish the cartridge and whether the ink tank is brandnew cannot be distinguished, a used ink cartridge happens to be mounted by mistake, thus leaving the control of the cartridge to a user.

### SUMMARY OF THE INVENTION

An object of the present invention is to provide an ink-jet printing apparatus, which is able to individually discriminate an ink tank and is able to inform ink remain.

In a first aspect of the present invention, there is provided a printing apparatus having a mounting portion for mounting an ink tank and performing printing by using a printing head ejecting an ink,

the apparatus comprising:

memory for storing the information;

writing means for writing the information into an information storing portion of the ink tank;

reading means for reading the information from the information storing portion of the ink tank; and

control means for setting the discrimination information at the ink tank and writing the discrimination information by the writing means, and storing the discrimination information in the memory.

In a second aspect of the present invention, there is provided a printing method performing printing by using a mounting portion for mounting an ink tank and a printing head ejecting an ink,

the method comprising:

storing step of storing the information in memory;

writing step of writing the information into an information storing portion of the ink tank;

reading step of reading the information from the information storing portion of the ink tank; and

control step of setting the discrimination information at the ink tank and writing the discrimination information, and storing the discrimination information in the memory.

The above and other objects, effects, features and advantages of the present invention will become more apparent from the following description of embodiments thereof taken in conjunction with accompanying drawings.

### BRIEF DESCRIPTION OF THE DRAWINGS

FIG. 1 is a block diagram as a first embodiment according to the present invention;

FIG. 2A is a plain view and FIG. 2B is a side view for showing arrangement of the contact lever and the carriage;

FIG. 3 is a schematic view for showing the fuse label;

FIG. 4 is a flowchart for showing an example of a controlling program stored in the ROM of FIG. 1;

FIG. 5 is a flowchart for showing an example of an ink remain detecting program in the ROM of FIG. 1;

FIG. 6 is a block diagram as a second embodiment according to the present invention;

FIG. 7A is a front view for the writing reading system and FIG. 7B is a plain view for showing arrangement of the writing reading system and the carriage; and

FIG. 8 is a schematic view for the construction of the memory portion as a second embodiment according to the present invention.

### DETAILED DESCRIPTION OF PREFERRED EMBODIMENTS

Preferred embodiments of the present invention will be described in detail with reference to the drawings.

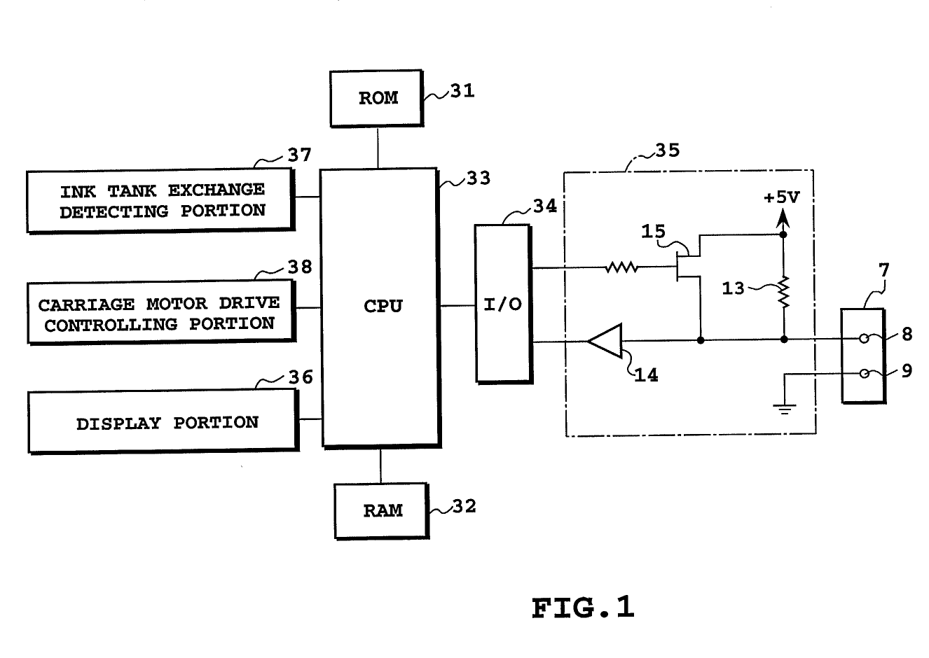

The first embodiment of the present invention will be described with reference to FIGS. 1 to 5.

An ink-jet printing apparatus is as follows.

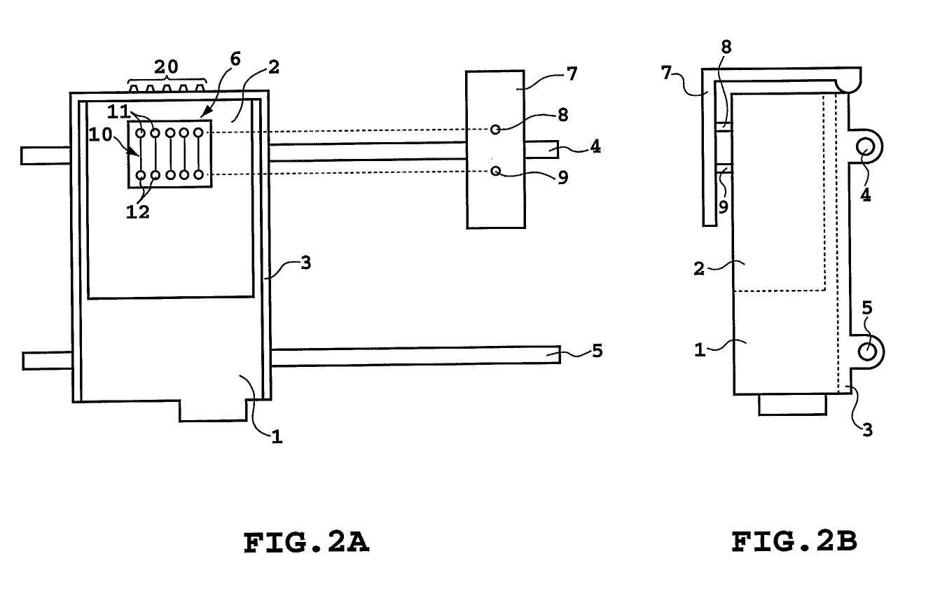

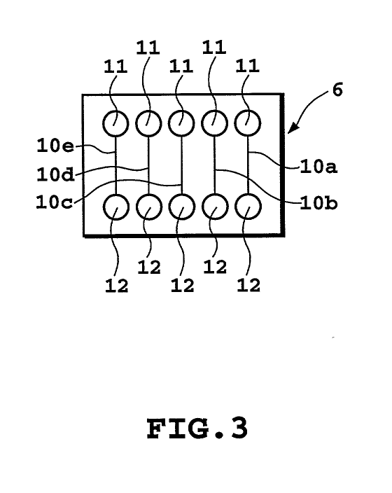

As shown in FIG. 1, a reference numeral 7 denotes a contact lever. FIG. 2 shows the structure of the contact lever 7. A reference numeral 35 denotes an information writing reading circuit. As shown in FIG. 3, the information writing reading circuit 35 performs a process of writing and reading about the fuse patterns 10. That is to say, the process writes the information of “brandnew” or “used”, the information of “ink remain full” or “ink remain empty”, and the information of “individual discrimination number” onto the fuse patterns 10, and reads those informations from the fuse patterns 10.

A reference numeral 37 is an ink tank exchange detecting portion detecting the movement of exchange. A reference numeral 38 is a carriage motor drive controlling portion which drives a carriage motor (not shown) and moves the carriage 3 (see FIG. 2) to the contact lever 7 when the ink tank exchange detecting portion 37 detects the exchange of the ink tank. A reference numeral 31 is an ROM (read only memory) storing controlling program.

A reference numeral 32 is an RAM (random access memory). The RAM 32 stores the individual discrimination number according to each of the plurality of the ink tanks and is used working area for the CPU 33. In this embodiment, when the brandnew ink tank is mounted with the carriage 3, the individual discrimination number according to the brandnew ink tank is set, and the individual discrimination number is memorized in the information memorizing portion of the ink tank and is stored in the RAM 32. Thus, the newly mounted ink tank can be distinguished and the information, such as ink remain in the ink tank, can be controlled individually.

A portion of the RAM 32 is utilized for the integrating counter groups structured by 8 integrating counters according to the maximum individual discrimination number, and each integrating counter corresponds to the individual discrimination number. The CPU 33 adds the number of printing dots outputted from the gate alley to the original stored value per line. The reference numeral 33 is the CPU (central processing unit) controlling each portion according to control program. The CPU 33 drives the information writing reading circuit 35 via I/O (input/output) 34 and selects a counter according to the individual discrimination number read out the information writing reading circuit 35 among the counter groups in the RAM 32, and controls the carriage motor drive controlling portion 38 when the ink tank exchange detecting portion 37 detects the exchange of the ink tank.

As the individual discrimination number, 0 is set at the first used ink tank and a numeral is successively set until 7, and then 0 is set. A reference numeral 36 is a display portion. The display portion 36 displays the state in which the ink remain of the ink tank is below and the ink remain is empty, and informs a user of alarm.

The information writing reading circuit 35 will be described in detail.

The contact 8 of the contact level 7 is connected to the power supply via the pull-up resistance 13 and is connected to the CPU 33 via the buffer 14 and the I/O 34. The contact 9 of the contact lever 7 is connected to the earth. When the contacts 8 and 9 are contacted to the pads 11 and 12 of the fuse patterns 10, a short may be occurred between the contacts 8 and 9 via a fuse. A L (=low level) signal is outputted via the buffer 14 when a short has occurred, and A H (=high level) signal is outputted via the buffer 14 when a short has not occurred.

On the other hand, the FET (filed effect transistor) 15 is connected to the pull-up resistance 13 in parallel, and the gate of the FET 15 is connected to the CPU 33 via the I/O 34. When a fuse blowing signal is outputted from the CPU 33, the FET 15 starts up and electric current flows to a fuse between the contacts 8 and 9, then the fuse is blown.

FIG. 2 shows the placement relationship between the contact lever 7 and the carriage 3.

In FIG. 2, a reference numeral 1 is an ink-jet head which generates a bubble in the ink by using thermal energy and ejects an ink from the printing head. A reference numeral 2 is an exchangeable ink tank having the fuse label 6.

FIG. 3 is a schematic view for showing the fuse label 6 in detail.

The fuse patterns 10a-10e are formed by etching the fuse label 6 and the electric pads 11 and 12 are arranged at the both side of the fuse patterns 10. The fuse patterns 10a to 10e are used for storing “the information”. The first fuse 10a indicates “brandnew” according to non-blowing or “used” according to blowing. The second fuse 10b indicates “ink remain full” according to non-blowing or “ink remain empty” according to blowing. The third fuse 10c to the fifth fuse 10e correspond to weights of 1, 2, 4, and can indicate the individual discrimination numbers of 0 to 7 inclusive. For example, when both the fourth fuse 10d and the fifth fuse 10e have been blown, 6 is indicated as the individual discrimination number.

A reference numeral 3 is a carriage for mounting the ink-jet head 1 and the ink tank 2. As shown in FIG. 2, the carriage 3 moves along the guide bars 4 and 5. Five projections 20 are formed on the side of the carriage 3 according to the first fuse 10a to the fifth fuse 10e. A reference numeral 7 is a contact lever shaped like “reverse-L” and is positioned at the edge in the moving area of the carriage 3. When the carriage 3 moves until the contact lever 7, the contact lever 7 is vibrated by the projections 20, then the contacts 8 and 9 are connected to the electric pads 11 and 12 at the both sides of the fuse patterns 10.

By the movement of the carriage 3, the ejection openings of the printing head eject ink onto the printing medium to perform one-line printing. The movement of the printing medium according to the one-line width (the predetermined area, such as printing width according to one scanning by using the ink-jet head 1) is repeatedly performed every one-line printing to form the image according to a sheet. The carriage 3 cannot reach to the contact lever 7 at normal printing and can reach to the contact lever 7 when the printing head 1 or the ink tank 2 is exchanged.

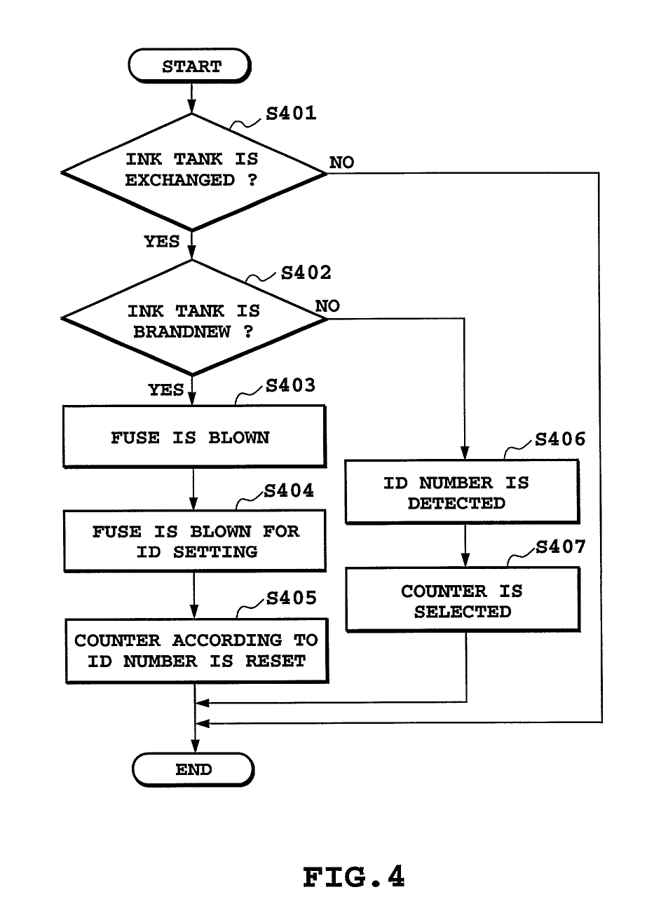

FIG. 4 is a flowchart for showing a controlling program memorized in the ROM 31.

When the ink tank 2 is exchanged at the predetermined position by a user, a switch operates and the ink tank exchange detecting portion 37 detects the exchange of the ink tank 2 (S401). Thus, the carriage motor drive controlling portion 38 drives a carriage motor and the carriage 3 is moved to the contact lever 7. Further, the contact lever 7 is vibrated by the projections 20 on the side of the carriage 3 and the contacts 8 and 9 of the contact lever 7 are connected to the pads 11 and 12 of the first fuse 10a. By this connection, whether the ink tank 2 is “brandnew” or “used” can be distinguished according to signal level from the information writing reading circuit 35 (S402).

When the L signal is outputted from the information writing reading circuit 35, the exchanged ink tank is considered as “brandnew”, and the fuse blowing signal is outputted form the CPU 33 to blow the first fuse 10a (S403). The third fuse 10c to the fifth fuse 10e are blown according to the individual discrimination number next to the late used individual discrimination number stored in the RAM 32 (S404). Then, the integrating counter according to the individual discrimination number is selected from the integrating counter groups and the selected counter value is reset (S405).

On the other hand, when the H signal is outputted from the information writing reading circuit 35, the exchanged ink tank is considered as “used”, and the individual discrimination number written by the third fuse 10c to the fifth fuse 10e is read out (S406). The integrating counter according to the individual discrimination number is selected form the integrating counter groups, and the selected counter value is reset (S407).

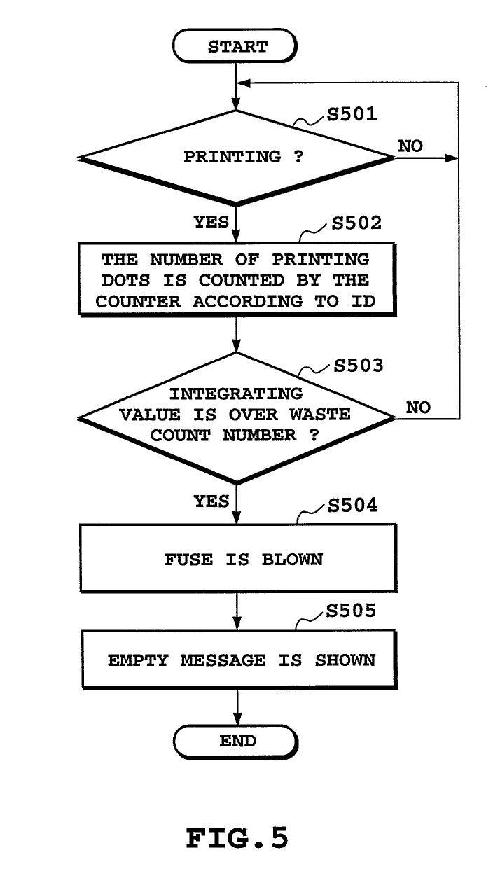

FIG. 5 is a flowchart for showing an ink remain detecting program stored in the ROM 31 of FIG. 1.

The printing image signal transferred from the host computer is received by the gate array of the ink-jet printing apparatus and is converted into image data according to the printing order of the ink-jet head 1 (S501). The number of printing dots per line is counted by the activated integrating counter (S502). The integrating value of the integrating counter is compared to the predetermined waste counter number of ink per line (S503). When the integrating value of the integrating counter is over the waste count number, the carriage motor is driven by the carriage motor drive controlling portion 38 and the carriage 3 is moved to the contact lever 7. When the contacts 8 and 9 get contact with the pads 11 and 12 of the second fuse 10b, the fuse blowing signal is outputted to blow the second fuse 10b (S504). When the ink remain in the ink tank is below, an empty message is shown on the display portion 36, and that makes a user exchange the ink tank (S505).

When the ink tank showing the low of the ink remain is set again, the information writing reading circuit 35 detects the blowing of the second fuse 10b and the H signal is outputted. Then, the display portion 36 shows that the ink in the ink tank is becoming empty, and that makes a user exchange the emptied ink tank, thus preventing a user from misoperating.

In the above example, the ink remain of the ink tank is becoming empty by displaying on the display portion 36 and that makes a user exchange. But, the present invention is not limited to the above example but can be applied to another method in which the ink remain in the ink tank is calculated by the integrating value of the integrating counter and the ink remain is shown to make a user exchange the emptied ink tank.

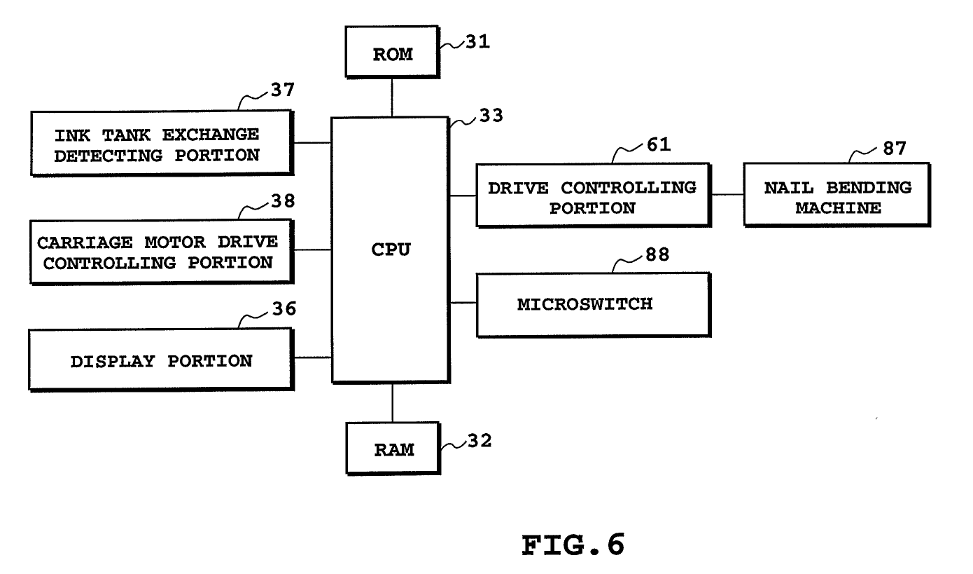

The second embodiment of the present invention will be described with reference to FIGS. 6 to 8.

This example is discrimination from the previous example in writing and reading information, because this embodiment is different from the previous embodiment in the structure of memory portion for storing information.

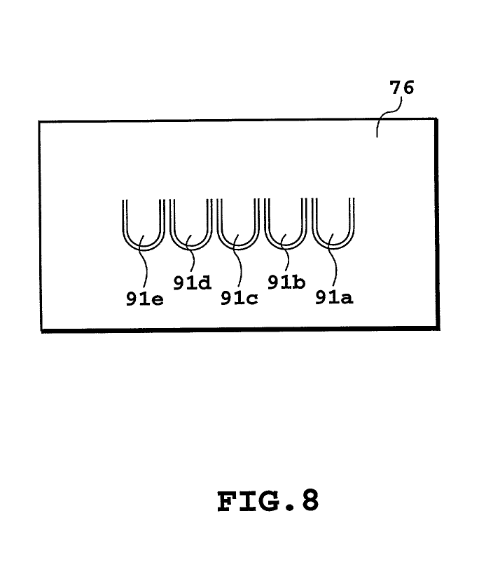

As shown in FIG. 8, the memory portion 76 according to the present invention is stuck on each of the ink tanks 2 and has 5 nails 91 performing plastic deformation according to a printing portion. The first nail 91a indicates “brandnew” when plastic deformation does not occur and it indicates “used” when plastic deformation occurs. The second nail 91b indicates “ink remain full” when plastic deformation does not occur and it indicates “ink remain empty” when plastic deformation occurs. The third nail 91c to the fifth nail 91e correspond to weights of 1, 2, 4, and can indicate the individual discrimination numbers of 0 to 7 inclusive. For example, when both the fourth nail 91d and the fifth nail 91e have been performed plastic deformation, 6 is indicated as the individual discrimination number.

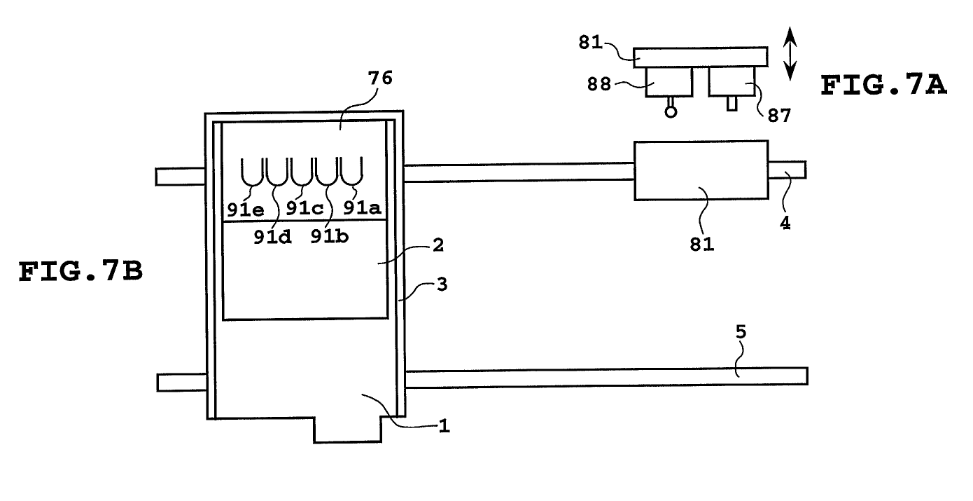

In FIG. 7, the writing reading system 81 is constructed by the nail bending machine 87 and the microswitch 88, and is positioned at the right side of the carriage 3 in the moving area.

As shown in FIGS. 6 and 7, the CPU 33 outputs a nail bending signal, and then the drive controlling portion 61 controls the nail bending machine 87 of the writing reading system 81 and the nail bending machine 87 bends the nail 91 to memorize the information onto the memory portion 76. When the microswitch 88 does not detect the bending of the first nail 91a, the nail bending signal is outputted from the CPU 33 at the time of between the first nail 91a and the nail bending machine 87 confronting each other. The nail bending signal is outputted from the CPU 33 according to the individual discrimination number at the time of between the nail indicating the individual discrimination number of the third nail 91c to the fifth nail 91e and the nail bending machine 87 confronting each other. When the second nail 91b indicates “ink remain empty”, the nail bending signal is outputted from the CPU 33 at the time of between the second nail 91b and the nail bending machine 87 confronting each other.

On the other hand, the microswitch 88 of the writing reading system 81 detects the bending of the nail 91 to read out information from the memory portion 76.

The present invention is not limited to the example of “nail-bending” but may be applicable for “nail-removing”.

As described above, the ink-jet printing apparatus includes the ink tank according to the printing head but may be able to include a monochromatic ink tank and a color ink tank according to the printing head.

The present invention is applicable for an ink-jet printing apparatus by using the cartridge type head having an ink tank and a printing head is structured in a body. Similarly, the present invention is also applicable for an ink-jet printing apparatus having a monochromatic printing head cartridge and a color printing head cartridge in the type of an ink tank and printing head is structured in a body.

As mentioned above, the fuse performing electrical isolation is used for the information and the nail portions performing physical transformation is used for the information, as a construction for memorizing the information showing “brandnew” or “used”, the information showing ink remain and the individual discrimination number about an exchangeable ink tank and a head cartridge.

The present invention is not limited to the above construction but can be applicable for a method as follows.

Whether the ink tank is brandnew or not is distinguished when the ink tank is mounted, and the individual discrimination number according to the brandnew tank is memorized in a printing body for controlling, and further the information such as ink remain is memorized according to application. Therefore, memory means, such as the RAM for writing and reading information can be also applied to the present invention.

In the above example, the ink tank storing ink is described as the exchangeable portions. The present invention is not limited to the ink tank but can be applied to other exchangeable portions. For example, in the transcribing printing apparatus performing printing by using the ink ribbon, the individual discrimination number is memorized in the cassette having the ink ribbon when the cassette is mounted with the printing body, and the printing body may be able to control the usage rate of the ink ribbon according to the individual discrimination number.

As described above, according to the present invention, the printing apparatus can inform a user of the ink tank exchange time and can inform a user of ink remain.

Further, according to the present invention, when the exchangeable portions is mounted with the printing body, the printing body sets the individual discrimination information to the exchangeable portions and the printing body can memorize the set individual discrimination information. By controlling the individual discrimination information according to the using process per the information, whether the portion is brandnew or not can be distinguished when the portions is exchanged, and the printing body can confirm the using process individually when the portions is exchanged frequently, thereby improving the convenience and usefulness of printing.

The present invention has been described in detail with respect to preferred embodiments, and it will now be apparent from the foregoing to those skilled in the art that changes and modifications may be made without deportioning from the invention in its broader aspect, as it is the invention, therefore, in the apparent claims to cover all such changes and modifications as fall within the true spirit of the invention.

What is claimed is:

1. A printing apparatus having a mounting portion for mounting an ink tank and performing printing by using a printing head ejecting an ink,
said apparatus comprising:
memory for storing the information;
writing means for writing said information into an information storing portion of said ink tank;
reading means for reading said information from said information storing portion of said ink tank; and
control means for setting the discrimination information at said ink tank and writing said discrimination information by said writing means, and storing said discrimination information in said memory.

2. The printing apparatus as claimed in claim 1, wherein
said control means reads the information according to said discrimination information from said information storing portion of said ink tank by using said readout means, and sets the discrimination number at said ink tank to write said discrimination number and stores said discrimination information in said memory when said information according to said discrimination information is not detected.

3. The printing apparatus as claimed in claim 2, which further comprising:
detecting means for detecting the exchange of said ink tank according to removing said ink tank from said mounting portion or fitting said ink tank into said mounting portion
wherein
said control means reads said information according to said discrimination information from said information storing portion of said ink tank when said ink tank is exchanged.

4. The printing apparatus as claimed in claim 1, which further comprising:
distinction means for distinguishing the using the process about said ink tank mounted on said mounting portion
wherein
said control means stores said using the process of said ink tank according to each discrimination information in said memory.

5. The printing apparatus as claimed in claim 1, wherein
said control means writes the information showing said discrimination information and the using process of said ink tank into said information storing portion of said ink tank by using said writing means.

6. The printing apparatus as claimed in claim 1, which further comprising:
detecting means for detecting consuming rate of ink according to printing movement about said ink tank fitted into said mounting portion
wherein
said control means stores the information showing said consuming amount of ink according to the discrimination information of the ink tank in said memory.

7. The printing apparatus as claimed in claim 6, which further comprising:
distinction means for distinguishing whether ink remaining amount of said ink tank is below the predetermined value or not according to said consuming amount of ink
wherein
said control means writes the information showing said ink remain into said information storing portion of said ink tank by using said writing means when said ink remaining amount is below said predetermined value by using said distinction means.

8. The printing apparatus as claimed in claim 7, which further comprising:
alarm means for informing a user of alarm
wherein
said alarm means informs a user of alarm when said ink remain is below said predetermined value by using said distinction means.

9. The printing apparatus as claimed in claim 8, which further comprising:
detecting means for detecting the exchange of said ink tank according to removing said ink tank from said mounting portion or fitting said ink tank into said mounting portion
wherein
said control means reads said information showing said ink remain from said information storing portion of said ink tank when said ink tank is exchanged, and informs a user of alarm when said ink remain of said ink tank is below said predetermined value according to said information showing said ink remain.

10. The printing apparatus as claimed in claim 1, wherein
said printing head is an ink-jet head performing printing by ejecting an ink.

11. The printing apparatus as claimed in claim 1, wherein
said printing head is a head ejecting an ink by utilizing a thermal energy, and includes an element generating a thermal energy applied to said ink.

12. A printing method performing printing by using a mounting portion for mounting an ink tank and a printing head ejecting an ink,
said method comprising:
storing step of storing the information in memory;
writing step of writing said information into an information storing portion of said ink tank;
reading step of reading said information from said information storing portion of said ink tank; and
control step of setting the discrimination information at said ink tank and writing said discrimination information, and storing said discrimination information in said memory.

13. The printing method as claimed in claim 12, wherein
said control step comprising:
reading the information according to said discrimination information from said information storing portion of said ink tank;
setting the discrimination number at said ink tank to write said discrimination number; and
storing said discrimination information in said memory when said information according to said discrimination information is not detected.

14. The printing method as claimed in claim 13, which further comprising:
detecting step of detecting the exchange of said ink tank according to removing said ink tank from said mounting portion or fitting said ink tank into said mounting portion
wherein
said control step comprising:
reading said information according to said discrimination information from said information storing portion of said ink tank when said ink tank is exchanged.

15. The printing method as claimed in claim 12, which further comprising:
distinction step of distinguishing the using the process about said ink tank fitted into said mounting portion
wherein
said control step comprising:
storing said using the process of said ink tank according to each discrimination information in said memory.

16. The printing method as claimed in claim 12, wherein
said control step comprising:
writing the information showing said discrimination information and the using process of said ink tank into said information storing portion of said ink tank.

17. The printing method as claimed in claim 12, which further comprising:
detecting step of detecting consuming rate of ink according to printing movement about said ink tank fitted into said mounting portion
wherein
said control step comprising:
storing the information showing said consuming rate of ink according to the discrimination information of the ink tank in said memory.

18. The printing method as claimed in claim 17, which further comprising:
distinction step of distinguishing whether ink remain of said ink tank is below the predetermined value or not according to said consuming rate of ink
wherein
said control step comprising:
writing the information showing said ink remain into said information storing portion of said ink tank when said ink remain is below said predetermined value.

19. The printing method as claimed in claim 18, which further comprising:
alarm step of informing a user of alarm
wherein
said alarm step comprising:
informing a user of alarm when said ink remain is below said predetermined value.

20. The printing method as claimed in claim 19, which further comprising:
detecting step of detecting the exchange of said ink tank according to removing said ink tank from said mounting portion or fitting said ink tank into said mounting portion
wherein
said control step comprising:
reading said information showing said ink remain from said information storing portion of said ink tank when said ink tank is exchanged; and
informing a user of alarm when said ink remain of said ink tank is below said predetermined value according to said information showing said ink remain.

21. The printing method as claimed in claim 12, wherein
said printing head is an ink-jet head performing printing by ejecting an ink.

22. The printing method as claimed in claim 12, wherein
said printing head is a head ejecting an ink by utilizing a thermal energy, and includes an element generating a thermal energy applied to said ink.
